(19) United States
(12) Patent Application Publication
(10) Pub. No.: US 2006/0243298 A1
(43) Pub. Date: Nov. 2, 2006

(54) Dental floss compositions comprising menthol and carboxamides

(75) Inventor: Deanna Kimberly Hamant, Morrow, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/400,361

(22) Filed: Apr. 7, 2006

Related U.S. Application Data
(60) Provisional application No. 60/675,545, filed on Apr. 28, 2005.

(51) Int. Cl. A61C 15/00

(52) U.S. Cl. 132/321

(57) ABSTRACT

The present invention relates to a dental floss or dental article comprising: a. a monofilament substrate; b. a coating composition coated on the monofilament substrate comprising a mixture of menthol and a coolant selected from the group consisting of N-substituted-p-menthane-carboxamides, and mixtures thereof; wherein the ratio of the coolant to menthol is from about 1:1 to about 2.5:1.

### CROSS REFERENCE TO RELATED APPLICATIONS

The present application claims priority to U.S. Provisional Patent Application No. 60/675,545, filed Apr. 28, 2005.

### TECHNICAL FIELD

The present invention relates to flavored dental articles having reduced bitterness as well as a unique and long lasting cooling perception which is achieved by using specific amount of coolants in relation to the total menthol levels used herein.

### BACKGROUND ART

It is known to add mint flavoring to dental articles for desirable taste characteristics and to provide breath freshening properties.

A large component of mint flavoring is menthol. Menthol is well known for its physiological cooling effect on the skin and mucous membranes of the mouth and has been extensively used as a flavouring agent (menthol being a major constituent of oil of peppermint) in consumer products such as dentifrices, mouthwashes, etc.

It is well established that the “cooling” effect of menthol is a physiological effect due to the direct action of menthol on the nerve endings of the human body responsive for the detection of hot or cold and is not due to latent heat of evaporation. It is believed that the menthol acts as a direct stimulus on the cold receptors at the nerve endings which in turn stimulate the central nervous system.

Although menthol is well established as a physiological coolant its use, in some compositions, is circumscribed by its strong minty odour and its relative volatility. Mint, too, provides some undesirable properties such as bitterness. Menthol has a tendency to distort flavor notes and render products having a bitter taste perception if not used in proper amounts.

In addition the use of flavored dental articles and dental floss is known in the prior art. Dental flosses are used to remove bacterial debris and plaque from interdental surfaces otherwise unreachable by conventional toothbrushes. Dental flosses are comprised of either several polymeric fibers combined to form a single strand, or alternatively a single polymeric fiber, or monofilament.

Monofilament flosses have become popular among the flossing community due to the reduced amount of fraying and/or shredding associated with them versus multi-filament flosses. In particular, monofilament flosses have been developed using fluorinated polymers such as polytetrafluoroethylene (PTFE) because of the low coefficient of friction (COF) associated with the compounds. The reduced COF allows for easy sliding between tight dental contacts where ordinary multi-filament flosses would perhaps shred or break upon insertion.

Monofilaments, however, are much harder to supply with substantial flavor due to the decreased surface area upon which coating materials can adhere when compared to their multi-filament counterparts. Also, with some monofilaments, no splaying of the bundle occurs to expose flavor particles trapped on inner fibers. The surface characteristics of PTFE make coating more difficult. In addition although the flavoring of dental articles is not new, the solution to the problem of providing a strong, high impact and long lasting flavor on a monofilament floss or monofilament dental articles, and even more particularly PTFE monofilament floss, has proved to be difficult. Concentrated flavor oils are frequently used in prior art dental flosses for flavor. Such flavor oils are volatile at the high temperatures required to melt common carrier materials (e.g. microcrystalline wax, beeswax and the like) used to coat flosses and thus the impact of the flavor is greatly lost during heating and processing. Also, the large surface area of floss increases the coatings exposure to air and thus greater loss of flavor. Therefore, prior art monofilament dental articles and floss may use coating compositions having high levels of flavor oils due to their volatility and loss upon heating and storage and due to the low surface area for adherence of the monofilament substrate as compared to a multifilament substrate. This tendency to increase the levels of flavor oils may translate into higher menthol levels and the potential for increase bitterness of the flavor.

While the prior art discloses providing flavored dental articles and flosses, none of the prior art provides guidance as to a coating composition which provides the consumer with a unique and long lasting cooling perception without bitterness from mint flavoring, especially on a monofilament substrate. These advantages are achieved by including a coolant having relatively low volatility in the coating composition.

### SUMMARY OF THE INVENTION

The present invention relates to a dental floss or dental article comprising:
a. a monofilament substrate;
b. a coating composition coated on the monofilament substrate comprising a mixture of menthol and a coolant selected from the group consisting of N-substituted-p-methane-carboxamides, acyclic carboxamides, and mixtures thereof;
wherein the ratio of the coolant to menthol is from about 1:1 to about 2.5:1.

### DESCRIPTION OF THE INVENTION

Definitions

By “dental article” as used herein is meant a product which is a molded device having a dental floss retained therein.

By “oral care composition” or “oral composition” as used herein is meant a product which is not intentionally swallowed for purposes of systemic administration of therapeutic agents, but is retained in the oral cavity for a sufficient time to contact some or substantially all of the dental surfaces and/or oral mucosal tissues for purposes of oral activity. In addition these terms can mean a product which may be intentionally swallowed but not swallowed for the purposes of systemic administration of therapeutic agents.

By “oral condition” as used herein is meant diseases or conditions of the oral cavity including caries, plaque, breath malodor, dental erosion, gingivitis, and periodontal disease. Oral conditions are further described in WO 02/02096A2, published Jan. 10, 2002, P&G.

By “safe and effective amount” as used herein is meant an amount of a component, high enough to significantly (positively) modify the condition to be treated or to effect the desired anticaries result, but low enough to avoid serious side effects (at a reasonable benefit/risk ratio), within the scope of sound medical/dental judgment. The safe and effective amount of a component, will vary with the particular condition (e.g., to effect anticaries activity or remineralization effect) being treated, the age and physical condition of the patient being treated, the severity of the condition, the duration of treatment, the nature of concurrent therapy, the specific form employed, and the particular vehicle from which the component is applied.

Herein, “comprising” means that other steps and other ingredients which do not affect the end result can be added. This term encompasses the terms “consisting of” and “consisting essentially of”. “Monofilament” floss or dental article as used herein means a single thread-like material suitable for use in cleaning between teeth which may be any shape for example circular, square, rectangular or other desired shape.

All percentages and ratios used hereinafter are by weight of total composition, unless otherwise indicated.

All measurements referred to herein are made at 25° C. unless otherwise specified.

All percentages, ratios, and levels of ingredients referred to herein are based on the actual amount of the ingredient, and do not include solvents, fillers, or other materials with which the ingredient may be combined as a commercially available product, unless otherwise indicated.

All publications, patent applications, and issued patents mentioned herein are hereby incorporated in their entirety by reference. Citation of any reference is not an admission regarding any determination as to its availability as prior art to the claimed invention. To the extent that any meaning or definition of a term in this written document conflicts with any meaning or definition of the term in a document incorporated by reference, the meaning or definition assigned to the term in this written document shall govern.

### Monofilament Substrate

The monofilament substrate may be formed from a variety of natural or synthetic materials for example nylon, polyethylene, ultra high molecular weight polyethylene, polyamides; polypropylene, fluorinated polymers such as polytetrafluoroethylene (PTFE); expanded polytetrafluoroethylene (ePTFE); rayon; Dacron, acrylic, polyesters; acetate polymers; polyolefins; block copolymers; cotton; wool; silk; linen, and mixtures thereof. The monofilament substrate may have any desired shaped cross-section. In one embodiment, the monofilament substrate is expanded porous PTFE such as those described in U.S. Pat. No. 5,518,012, Dolan et al.; a towed PTFE such as those described in U.S. Pat. No. 5,765,576, Dolan et al.; U.S. Pat. No. 5,566,691 Dolan et al.; U.S. Pat. No. 5,718,251 Gray et al.; U.S. Pat. No. 5,878,758 Bacino et al.; low density floss such as those described in U.S. Pat. No. 6,539,951 Baillie et al.

U.S. Pat. No. 6,539,951, Baillie et al., teaches a fiber having a thickness of 0.0015″ to 0.04″, a width of 0.3 to 4 mm (0.01″ to 0.16″), and a denier of about 100 to about 3,500. Most importantly, the fiber should have a density of less than about 0.8 g/cc, and in alternative embodiments less than about 0.7 g/cc, less than about 0.6 g/cc, less than about 0.5 g/cc, less than about 0.4 g/cc, less than about 0.3 g/cc, and less than about 0.2 g/cc. Each of these properties is measured in a conventional manner, for example thickness may be determined through any conventional means such as through the use of calipers, a snap gage, optical comparitors, or even a scanning electron microscope. Density may be determined by dividing the measured mass of a sample of fiber (without any coating or additive) by the computed volume of the sample. Volume may be computed by multiplying the measured length, width, and thickness of the sample for substantially rectangular cross-sections, or by other known calculations for other cross-sectional shapes to obtain the most accurate approximation of the volume. Denier is the measured mass of the sample (without any coating or additive) in grams per 9000 meters of length. As disclosed in U.S. Pat. No, 6,539,951, Baillie et al., these advantageous features of the fiber are achieved through non-contact heating of the fiber which is believed to help produce a rougher surface on the fiber than is achieved with plate contact heating. This rougher surface in turn contributes to higher surface friction and better grippability for the this floss.

In another embodiment the floss of the present invention comprises a single relatively thick strand of expanded polytetrafluoroethylene (ePTFE) fiber that is essentially rectangular to oblong in cross-sectional dimensions and is formed substantially without folds or creases, as disclosed in U.S. Pat. No. 5,518,012, Dolan et al. In order to form the floss without folding one or both of its edges over itself, as is required with existing flosses, it is particularly important that this floss is formed to have a significantly greater thickness dimension than other prior art PTFE floss fibers. For example, prior to folding, older conventional expanded PTFE floss fiber sold under the trademark GLIDE® by W. L. Gore & Associates, Inc., has typical dimensions of about 40 μm in thickness and about 2 mm in width. When this material is folded and packaged as dental floss, the material typically has dimensions of about 90 μm in thickness and about 1.2 mm in width. The PTFE floss sold under the name EASY SLIDE by Johnson & Johnson has typical unfolded dimensions of about 23 μm in thickness and about 2.3 mm. When this material is folded and packaged as dental floss, the material typically has dimensions of about 75 μm in thickness and about 1.3 mm in width.

The floss presented in U.S. Pat. No. 5,518,012, Dolan et al., forms essentially a rectangular to oblong cross-sectional dimension. Typical dimensions comprise about 50 to about 250 μm, in another embodiment from about 75 to about 150 μm, in thickness and about 0.5 to about 3 mm, and in another embodiment about 0.7 to about 1.5 mm, in width. The substantial thickness of this material allows the floss to function extremely well without need for folding or otherwise bulking the height of the material. Additionally, the fiber's rectangular to oblong cross-sectional shape is similar to that obtained by the other commercial flosses, but, again, without folding.

Also this is highly resistant to fibrillating along its edges during use. The elimination of this fibrillation problem is an important advancement over previous expanded PTFE floss materials, where one of the purposes of folding was to reduce the number of exposed edges on the floss' outer surface subject to fibrillation.

Each of these properties is measured in a conventional manner. Width and thickness is determined through any conventional means, such as through the use of calipers or through measurements through a scanning electron microscope. Density is determined by dividing the measured weight of the sample by the computed volume of the sample. The volume is computed by multiplying the measured length, width, and thickness of the sample. Tenacity is calculated by dividing the sample's tensile strength by its normalized weight per unit length (tex [grams/1000 meters] or denier [grams/9000 meters]).

The final dimensions of this fiber should comprise: a width of about 0.5 to about 3.0 mm; a thickness of about 50 to about 250 μm; a weight/length of about 80 to about 450 tex; a density of about 1.0 to about 1.9 g/cc; a tensile strength of about 1.5 to 15 kg; and a tenacity of about 10 to 40 g/tex. These measurements were made in a conventional manner. Bulk tensile strength was measured by a tensile tester, such as an INSTRON Machine of Canton, Mass. In the case of sheet goods, the INSTRON machine was outfitted with clamping jaws which are suitable for securing the sheet goods during the measurement of tensile loading. The cross-head speed of the tensile tester was 25.4 cm per minute. The gauge length was 10.2 cm. In the case of fibers, the INSTRON machine was outfitted with fiber (horn type) jaws that are suitable for securing fibers and strand goods during the measurement of tensile loading. The cross-head speed of the tensile tester was 25.4 cm per minute. The gauge length was 25.4 cm.

This floss also exhibits increased porosity or “void content.” The void content is measured by the ratio of the article's bulk density to its intrinsic density. When processed the floss remains quite porous and compressible in its completed form and has the ability to densify under low stress. This property makes the floss easier to handle and more comfortable when applied between teeth and gums. As a result, the floss will densify when squeezed through a tight area, such as when passed between teeth during flossing, to produce a better cleaning action than that possible with conventional flosses by wiping across a greater portion of the area of the teeth.

### Coolant and Menthol

One or more coolants are present in the compositions at a level of from about 0.001% to about 25%, in another embodiment from about 8% to about 20%, in another embodiment from about 15% to about 20%, by weight of the coating composition.

In one embodiment the coolant is a N-substituted-p-menthane-carboxamides that fall within the following formula. These carboxamides have a pronounced physiological cooling activity, which has little or no odour, which are of relatively low volatility and which are substantially non-toxic and are under the following formula: 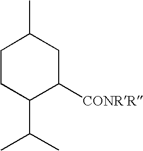
where R′, when taken separately, is hydrogen or an aliphatic radical containing up to 25 carbon atoms;
R″, when taken separately is hydroxy, or an aliphatic radical containing up to 25 carbon atoms, with the proviso that when R′ is hydrogen R″ may also be an aryl radical of up to 10 carbon atoms and selected from the group consisting of substituted phenyl, phenalkyl or substituted phenalkyl, naphthyl and substituted naphthyl, pyridyl; and
R′ and R″, when taken together with the nitrogen atom to which they are attached, represent a cyclic or heterocyclic group of up to 25 carbon atoms, e.g. piperidino, morpholino etc.

In the above definitions “aliphatic” is intended to include any straight-chained, branched-chained or cyclic radical free or aromatic unsaturation, and thus embraces alkyl, cycloalkyl, alkenyl, cycloalkenyl, alkynyl, hydroxyalkyl, acyloxyalkyl, alkoxy, alkoxyalkyl, aminoalkyl, acylaminoalkyl, carboxyalkyl and similar combinations.

Typical values for R′ and R″ when aliphatic are methyl, ethyl, propyl, butyl, isobutyl, n-decyl, cyclopropyl, cyclohexyl, cyclopentyl, cycloheptylmethyl, 2-hydroxyethyl, 3-hydroxy-n-propyl, 6-hydroxy-n-hexyl, 2-aminoethyl, 2-acetoxyethyl, 2-ethylcarboxyethyl, 4-hydroxybut-2-ynyl, carboxymethyl etc.

When R″ is aryl typical values are benzyl, naphthyl, 4-methoxyphenyl, 4-hydroxyphenyl, 4-methylphenyl, 3-hydroxy-4-methylphenyl, 4-fluorophenyl, 4-nitrophenyl, 2-hydroxynaphthyl, pyridyl, etc.

These compounds are recited in U.S. Pat. No. 4,136,163, Watson, et al., issued Jan. 23, 1979. In one embodiment the coolant is N-ethyl-p-menthane-3-carboxamide known as “WS-3” (available from Givaudan) at a level of from about 8% to about 23% by weight of the coating composition. It should be noted that these compounds are quite similar structurally to menthol itself.

In another embodiment the coolant is an acyclic carboxamides selected from those disclosed in U.S. Pat. No. 4,230,688, Rowsell, et al., issued Oct. 28, 1980.

The carboxamides of the '688 patent are certain acyclic tertiary and secondary carboxamides. These have the structure 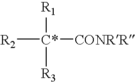
where R′ and R″, when taken separately, are each hydrogen, C₁-C₅ alkyl or C₁-C₈ hydroxyalkyl and provide a total of no more than 8 carbon atoms, with the proviso that when R′ is hydrogen R″ may also be alkylcarboxyalkyl of up to 6 carbon atoms;

R′ and R″, when taken together, represent an alkylene group of up to 6 carbon atoms, the opposite ends of which group are attached to the amide nitrogen atom thereby to form a nitrogen heterocycle, the carbon chain of which may optionally be interrupted by oxygen;

R₁ is hydrogen or C₁-C₅ alkyl; and R₂ and R₃ are each C₁-C₅ alkyl; with the provisos that (i), R₂ and R₃ together provide a total of at least 5 carbon atoms, preferably from 5-10 carbon atoms; and (ii) when R₁ is hydrogen, R₂ is C₂-C₅ alkyl and R₃ is C₃-C₅ alkyl and at least one of R₂ and R₃ is branched, preferably in an alpha or beta position relative to the carbon atom marked (*) in the formula.

While the carboxamide compounds are generally insoluble in water, they may be employed in the coating composition of the dental article as particulate solids and added directly to the coating composition or blended with other solid ingredients used to make the coating composition. The coolant may be added in several forms, such as in the form of an encapsulate, or previously dissolved in a polar solvent and/or mixed with a flavor oil and then used in the composition. Encapsulation may be achieved using conventional procedures for example, the encapsulation may be performed using water-insoluble as well as water-soluble agents. The use of encapsulation may be beneficial when a delay in cooling perception is desired. When the carboxamides are dissolved in a polar solvent such solvents may be selected from a wide variety of materials. In one embodiment solvents are selected from the group consisting of ethyl alcohol, ethylacetate, diethyl ether, isopropyl alcohol and glycerin.

In another embodiment coolants in the present compositions are the paramenthan carboxyamide agents such as N-ethyl-p-menthan-3-carboxamide, known commercially as “WS-3 ”, N,2,3-trimethyl-2-(1-methylethyl)butanamide, known as “WS-23,” and mixtures thereof. Additional coolants may be selected from the group consisting of menthol, 3-1-methoxypropane-1,2-diol known as TK-10 manufactured by Takasago, menthone glycerol acetal known as MGA manufactured by Haarmann and Reimer, menthyl lactate known as Frescolat® manufactured by Haarmann and Reimer and monomenthyl succinate known as Physcool® from Mane, further disclosed in U.S. Pat. No. 5,725,865, V. Mane Fils. The terms menthol and menthyl as used herein include dextro -and levorotatory isomers of these compounds and racemic mixtures thereof. TK-10 is described in U.S. Pat. No. 4,459,425, Amano et al., issued Jul. 10, 1984.

The present invention further comprises a safe and effective amount of menthol. Generally, the coating composition of the present invention comprises from about 0.01% to about 20%, in another embodiment from about 1% to about 15%, in another embodiment from about 3% to about 10%, by weight of the coating composition, of menthol. In calculating the levels of menthol in the coating composition, the levels of menthol include those amounts of menthol from peppermint oil or other flavor oil containing menthol, as well as menthol that may be added directly to the coating composition.

In one embodiment the ratio of the coolant to menthol is from about from about 1:1 to about 2.5:1, in another embodiment is from about 1.3:1 to about 2:1, and in yet another embodiment is from about 1.5:1 to about 1.9:1. The ratios of coolant to menthol in the coating composition of the present invention are measured for the coating composition for fresh product and are measured within 3 days of manufacturing the dental floss or dental article.

### Optional Ingredients

Waxes

The present coating composition may optionally comprise a safe and effective amount of a natural or synthetic wax which may be water soluble or water insoluble waxes. These waxes include animal, vegetable, mineral, petroleum, and microcrystalline, waxes. Generally, the waxes that may be used in the coating composition herein include beeswax, candelilla, candela, carnauba, paraffin, microcrystalline wax, Fischer-Tropsch waxes, polyethylene waxes, fatty acid waxes, amide waxes, and mixtures thereof. In one embodiment the paraffin waxes useful herein generally have a melting point range of from about 68° C. to about 70° C.; the microcrystalline wax useful herein has a melting point of from about 65° C. to about 80° C.; the beeswax useful herein has a melting point of from about 62° to about 65° C. with a flash point of 242° C.; the candelilla wax useful herein has melting point of from about 68° to about 72° C.; the carnauba wax useful herein has a melting point of from about 83° to about 86° C.; the Fischer-Tropsch wax useful herein has a melting point of about 95° to about 120° C.; and the polyethylene waxes useful herein have melting point of from about 90° to about 120° C. Synthetic grades of beeswax, candelilla, and carnauba waxes are also available with similar properties as the natural grades.

Water-soluble waxes include polymers of ethylene oxide, in the form of relatively low molecular weight liquids and waxes, referred to as poly (ethylene glycol) or PEG, available in molecular weights ranging from 1,000 to 20,000. Typically, polymers with molecular weight below 20,000 are defined as PEG and those above 20,000 are poly (ethylene oxide)—(PEO). In one embodiment, the melting point of PEG is from about 45° to about 60° C.

Flavoring Agents

The present invention can optionally further comprise a safe and effective amount of a flavoring agent. Suitable flavoring agents include oil of wintergreen, oil of peppermint, oil of spearmint, clove bud oil, menthol, anethole, methyl salicylate, eucalyptol, 1-menthyl acetate, and mixtures thereof. Flavoring agents are generally used in the coating compositions at levels of from about 0.001% to about 5%, in another embodiment from about 0.1 to about 2%, by weight of the coating composition.

As mentioned above in order to improve their stability, flavor oils can be dispersed in a suitable matrix by a microencapsulation process. These flavor particles can be made by conventional procedures including spray-drying emulsions of flavor oils dispersed in a malto-dextrin solution optionally containing a non-toxic gum such as gum Arabic; extruding, tray-drying or drum-drying the emulsions to form solids which are then ground to the desired particle size; by coacervation or aqueous phase separation procedures which yield flavor droplets coated in a non-toxic coating such as gelatin. The amount of flavor in the particle can vary from 1 to 30%. Encapsulated flavor particles are described in the art for example U.S. Pat. Nos. 3,943,949; 3,957,964; 4,033,365; 4,071,614; 4,386,106; 4,515,769; 4,568,560 and 5,004,595.

Sweetening Agents

The present invention can optionally further comprise a safe and effective amount of a sweetening agent.

Sweetening agents which can be optionally used include sucralose, sucrose, glucose, saccharin, dextrose, levulose, lactose, mannitol, sorbitol, fructose, maltose, xylitol, saccharin salts, thaumatin, aspartame, D-tryptophan, dihydrochalcones, acesulfame and cyclamate salts, neotame, tagatose, especially acesulfame, sodium cyclamate and sodium saccharin, and mixtures thereof. In one embodiment the coating composition comprises from about 0.001% to about 10% of these agents, in another embodiment from about 0.01% to about 2%, by weight of the coating composition.

II. Application of the Coating Composition to the Monofilament Substrate

The coating composition is made by conventional processing. The coating composition of the present invention is applied to the monofilament substrate at a level of from about 2% to about 30%, in another embodiment from about 5% to about 20% and in yet another embodiment from about 10% to about 15% by weight (w/w) of coating composition (i.e. weight of coating/weight of monofilament substrate plus coating).

Further, in one embodiment the coating composition has a substantially uniform outer surface. In another embodiment the coating composition outer surface is not uniform.

The process of applying a coating to a fiber is well known in the art and is described in U.S. Pat. No. 5,220,932, Blass. The coating may be applied to the filament by other conventional techniques including, spraying or padding, etc.

Finally, after coating and drying if necessary, the fibers may be wound onto a spool with care taken to avoid rolling or folding of the fibers during the spooling process.

### EXAMPLES

The following non-limiting examples further describe preferred embodiments within the scope of the present invention. Many variations of these examples are possible without departing from the scope of the invention.

### Example I

| | 1 | 2 | 3 |
|---|---|---|---|
| | (% by wt of | (% by wt of | (% by wt of |
| | coating) | coating) | coating) |
| Beeswax | 80 | | 69 |
| Microcrystalline wax | | 78 | |
| Sodium Saccharin | | | 2 |
| Acesulfame K | 2 | 2 | |
| Peppermint Oil | 10 | 10 | 17 |
| WS-3¹ | 8 | | 6 |
| WS-23² | | 10 | 6 |
| Total | 100 | 100 | 100 |

¹N-ethyl-p-menthan-3-carboxamide
²N,2,3-trimethyl-2-(1-methyl ethyl) butanamide

All documents cited in the Detailed Description of the Invention are, in relevant part, incorporated herein by reference; the citation of any document is not to be construed as an admission that it is prior art with respect to the present invention.

While particular embodiments of the present invention have been described, it will be obvious to those skilled in the art that various changes and modifications of the present invention can be made without departing from the spirit and scope of the invention. It is intended to cover, in the appended claims, all such modifications that are within the scope of this invention.

What is claimed is:

1. A dental floss or dental article comprising:
c. a monofilament substrate;
d. a coating composition coated on the monofilament substrate comprising a mixture of menthol and a coolant selected from the group consisting of N-substituted-p-methane-carboxamides, and mixtures thereof;
wherein the ratio of the coolant to menthol is from about 1:1 to about 2.5:1.

2. The floss or article of claim 1 wherein the coolant is N-ethyl-p-menthane-3-carboxamide.

3. The floss or article of claim 1 wherein the coolant is N,2,3-trimethyl-2-(1-methylethyl)butanamide.

4. The floss or article of claim 1 wherein the coolant is a mixture of N-ethyl-p-methane-3-carboxamide and N,2,3-trimethyl-2-(1-methylethyl)butanamide.

5. The floss or article of claim 2 wherein the ratio is from about 1.3:1 to about 2:1.

6. The floss or article of claim 5 wherein the ratio is from about 1.5:1 to about 1.9:1.

7. The floss or article of claim 5 wherein the coating composition further comprises a natural or synthetic wax compound.

8. The floss or article of claim 7 wherein the wax is an insoluble wax selected from the group consisting of beeswax, candelilla, candela, carnauba, paraffin, microcrystalline wax, Fischer-Tropsch wax, polyethylene wax, fatty acid wax, amide wax, and mixtures thereof.

9. The floss or article of claim 2 wherein the monofilament substrate is a strand of expanded polytetrafluoroethylene (PTFE) fiber.

10. The floss or article of claim 9 wherein the monofilament substrate has a density of 1.0 to 1.9 g/cc and uniform dimensions of width and thickness along its length and having an outer surface of essentially rectangular to oblong cross-sectional dimension, the single fiber being without folds so that its outer surface is fully exposed.

11. The floss or article of claim 10 wherein the width of the floss is at least 0.5 mm and the thickness of the floss is at least 50 μm.

12. The floss or article of claim 11 wherein the floss comprises dimensions of at least 0.7 mm in width and at least 50 μm in thickness.

13. The floss or article of claim 12 wherein the fiber has sufficient porosity to allow the fiber to compress to at least 40% of its original thickness.

14. The floss or article of claim 13 wherein the fiber has a width of 0.5 to 3.0 mm and a thickness of 50 to 250 μm.

15. The floss or article of claim 1 wherein the fiber has a denier of about 100 to about 3,500 and a density of less than about 0.8 g/cc.

16. The floss or article of claim 15 wherein the fiber has a density of less than about 0.7 g/cc.

17. The floss or article of claim 16 wherein the fiber has a density of less than about 0.3 g/cc
